(19) United States
(12) Patent Application Publication
(10) Pub. No.: US 2024/0087552 A1
(43) Pub. Date: Mar. 14, 2024

(54) SOUND GENERATION METHOD AND SOUND GENERATION DEVICE USING A MACHINE LEARNING MODEL

(71) Applicant: Yamaha Corporation, Hamamatsu (JP)

(72) Inventor: Ryunosuke DAIDO, Hamamatsu (JP)

(21) Appl. No.: 18/512,121

(22) Filed: Nov. 17, 2023

Related U.S. Application Data
(63) Continuation of application No. PCT/JP2022/020724, filed on May 18, 2022.

(30) Foreign Application Priority Data
May 18, 2021 (JP) 2021-084180

(51) Int. Cl. G10H 7/00; G10H 1/46

(52) U.S. Cl. CPC G10H 7/002; G10H 1/46; G10H 7/008; G10H 2210/325

(57) ABSTRACT

A sound generation method includes receiving a control value at each of a plurality of time points on a time axis, accepting a mandatory instruction, generating an acoustic feature value of a specific time point, by using a trained model to process the control value and an acoustic feature value sequence, and updating the acoustic feature value sequence. The acoustic feature value sequence is updated by using the generated acoustic feature value, as the mandatory instruction has not been received for the specific time point. As the mandatory instruction has been received for the specific time point, one or more alternative acoustic feature values of one or more time points, which includes at least the specific time point, in accordance with the control value for the specific time point is generated, and the acoustic feature value sequence is updated by using the one or more alternative acoustic feature values.

### CROSS-REFERENCE TO RELATED APPLICATIONS

This application is a continuation application of International Application No. PCT/JP2022/020724, filed on May 18, 2022, which claims priority to Japanese Patent Application No. 2021-084180 filed in Japan on May 18, 2021. The entire disclosures of International Application No. PCT/JP2022/020724 and Japanese Patent Application No. 2021-084180 are hereby incorporated herein by reference.

### BACKGROUND

### Technological Field

This disclosure relates to a sound generation method and a sound generation device that can generate sound.

### Background Information

For example, AI (artificial intelligence) singers are known as sound sources that sing in the singing styles of particular singers. An AI singer learns the vocal characteristics of a particular singer to generate arbitrary sound signals simulating said singer. Preferably, the AI singer generates sound signals that reflect not only the vocal characteristics of the trained singer but also the user's instructions pertaining to singing style.

### SUMMARY

Jesse Engel, Lamtharn Hantrakul, Chenjie Gu and Adam Roberts, “DDSP: Differentiable Digital Signal Processing”, arXiv:2001.04643v1 [cs.LG] 14 Jan. 2020 describes a neural generative model that generates sound signals based on the user's input sound. In this generative model, during the generation of the sound signals, the user issues to the generative model instructions that pertain to control values, such as pitch or volume. If an AR (autoregressive) type generative model is used as the generative model, even if the user issues to the generative model an instruction pertaining to pitch, volume, etc., at a given point in time, depending on the sound signal being generated at that point in time, there will be a delay before the sound signal in accordance with the volume is generated. In such cases, due to the delays in following the control values, the use of an AR type generative model makes it difficult to generate sound signals in accordance with the user's intentions.

The object of this disclosure is to provide a sound generation method and a sound generation device that can generate sound signals in accordance with the user's intentions using an AR generative model.

A sound generation method according to one aspect of this disclosure is realized by a computer and comprises receiving a control value indicating the sound characteristics at each of a plurality of time points on a time axis, accepting a mandatory instruction at a desired time point on the time axis, using a trained model to process the control value at each time point and an acoustic feature value sequence stored in temporary memory, thereby generating an acoustic feature value at the time point, using the generated acoustic feature value to update the acoustic feature value sequence stored in the temporary memory if the mandatory instruction has not been received at that time point, and generating alternative acoustic feature values of one or more recent time points in accordance with the control value at that time point, and using the generated alternative acoustic feature values to update the acoustic feature value sequence stored in the temporary memory if the mandatory instruction has been received at that time point.

A sound generation device according to another aspect of this disclosure comprises a control value receiving unit that receives a control value indicating the sound characteristics at each of a plurality of time points on a time axis, a mandatory instruction receiving unit that accepts a mandatory instruction at a desired time point on the time axis, a generation unit that uses a trained model to process the control value at each time point and an acoustic feature value sequence stored in the temporary memory, thereby generating an acoustic feature value at the time point, and an updating unit that uses the generated acoustic feature value to update the acoustic feature value sequence stored in the temporary memory if the mandatory instruction has not been received at that time point, and that generates alternative acoustic feature values of one or more recent time points in accordance with the control value at that time point, and uses the generated alternative acoustic feature values to update the acoustic feature value sequence stored in the temporary memory if the mandatory instruction has been received at that time point.

### BRIEF DESCRIPTION OF THE DRAWINGS

FIG. 1 is a block diagram of the configuration of a processing system that includes a sound generation device according to an embodiment of this disclosure.

FIG. 2 is a block diagram of the configuration of a trained model serving as an acoustic feature value generator.

FIG. 3 is a block diagram of the configuration of the sound generation device.

FIG. 4 is a diagram of the feature value modification characteristics between an original acoustic feature value and an alternative acoustic feature value generated from the acoustic feature value.

FIG. 5 is a block diagram of the configuration of a training device.

FIG. 6 is a flowchart showing an example of a sound generation process performed by the sound generation device of FIG. 3.

FIG. 7 is a flowchart showing an example of a sound generation process performed by the sound generation device of FIG. 3.

FIG. 8 is a flowchart showing an example of a training process performed by the training device of FIG. 5.

FIG. 9 is a diagram illustrating the generation of an alternative acoustic feature value in a first modified example.

FIG. 10 is a diagram illustrating the generation of an alternative acoustic feature value in a second modified example.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### (1) CONFIGURATION OF THE PROCESSING SYSTEM

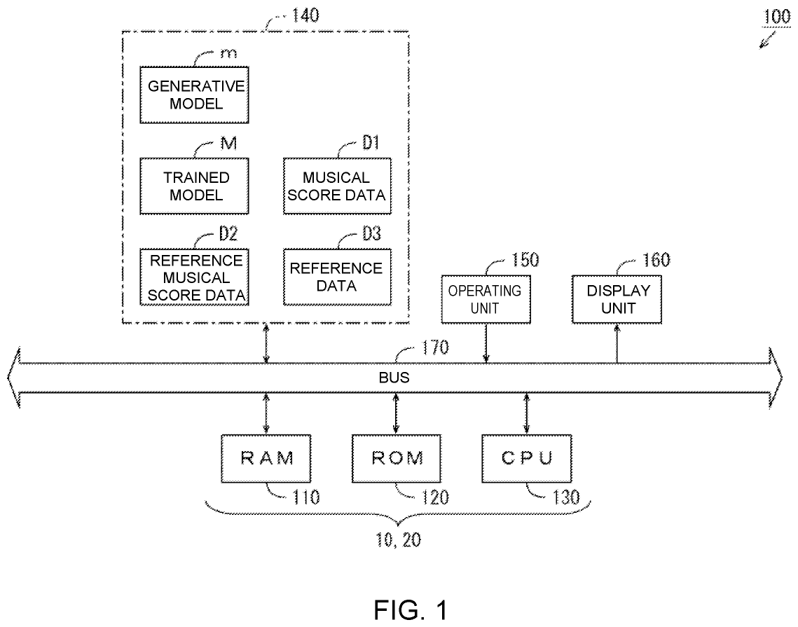

A sound generation method and a sound generation device according to an embodiment of this disclosure will be described in detail below with reference to the drawings. FIG. 1 shows a block diagram of the configuration of the processing system that includes the sound generation device according to an embodiment of this disclosure. As shown in FIG. 1, a processing system 100 includes RAM (random-access memory) 110, ROM (read-only memory) 120, CPU (central processing unit) 130, a memory unit (storage unit) 140, an operating unit 150, and a display unit 160.

The processing system 100 is realized by a computer, such as a PC, a tablet terminal, or a smartphone. Alternatively, the processing system 100 can be realized by co-operative operation of a plurality of computers connected by a communication channel, such as the Internet. The RAM 110, the ROM 120, the CPU 130, the memory unit 140, the operating unit 150, and the display unit 160 are connected to a bus 170. The RAM 110, the ROM 120, and the CPU 130 constitute a sound generation device 10 and a training device 20. In the present embodiment, the sound generation device 10 and the training device 20 are configured by the common processing system 100, but they can be configured by separate processing systems.

The RAM 110 is a volatile memory, for example, and is used as a work area for the CPU 130. The ROM 120 is a non-volatile memory, for example, and stores a sound generation program and a training program. The CPU 130 is one example of at least one processor as an electronic controller of the processing system 100. The CPU 130 executes a sound generation program stored in the ROM 120 on the RAM 110 to carry out a sound generation process. Further, the CPU 130 executes the training program stored in the ROM 120 on the RAM 110 to perform a training process. Here, the term “electronic controller” as used herein refers to hardware, and does not include a human. The processing system 100 can include, instead of the CPU 130 or in addition to the CPU 130, one or more types of processors, such as a GPU (Graphics Processing Unit), a DSP (Digital Signal Processor), an FPGA (Field Programmable Gate Array), an ASIC (Application Specific Integrated Circuit), and the like. Details of the sound generation process and the training process will be described below.

The sound generation program or the training program can be stored in the memory unit 140 instead of the ROM 120. Alternatively, the sound generation program or the training program can be provided in a form stored on a computer-readable storage medium and installed in the ROM 120 or the memory unit 140. Alternatively, if the processing system 100 is connected to a network, such as the Internet, a sound generation program distributed from a server (including a cloud server) on the network can be installed in ROM 120 or memory unit 140.

The memory unit (computer memory) 140 includes a storage medium such as a hard disk, an optical disk, a magnetic disk, or a memory card. The memory unit 140 stores a generative model m, a trained model M, a plurality of musical score data D1, a plurality of reference musical score data D2, and a plurality of reference data D3. The generative model m is an untrained generative model or a generative model trained in advance using data other than the reference data D3. Each piece of the musical score data D1 represents a time series (that is, a musical score) of a plurality of musical notes arranged on a time axis, which constitutes a musical piece.

The trained model M (as data) consists of algorithm data indicating an algorithm of a generative model that generates an acoustic feature value sequence corresponding to input data including control values indicating sound characteristics, and variables (trained variables) used for the generation of the acoustic feature value sequence by the generative model. The algorithm is of an AR (autoregressive) type and includes a temporary memory for temporarily storing the most recent acoustic feature value sequence and a DNN (deep neural network) that estimates the current acoustic feature value sequence from the input data and the most recent acoustic feature value sequence. In the following, for the sake of simplicity of the explanation, the generative model (as a generator) to which the trained variables are applied is also referred to as “trained model M.”

The trained model M receives as input data a time series of musical score feature values generated from the musical score data D1 and also receives control values indicating the sound characteristics at each time point of the time series, and processes the input data received at each time point and the acoustic feature value sequence temporarily stored in the temporary memory, thereby generating the acoustic feature values at the time points corresponding to the input data. Each of the plurality of time points on the time axis corresponds to each of a plurality of time frames used for short-time frame analysis of waveforms, and the time difference between two consecutive time points is longer than the period of a sample waveform in the time domain, generally from several milliseconds to several hundred milliseconds. Here, the interval between the time frames is assumed to be five milliseconds.

The control values that are input to trained model M are feature values indicating acoustic characteristics related to pitch, timbre, amplitude, etc., indicated by the user in real time. The acoustic feature value sequence generated by trained model M is a time series of feature values representing any one of acoustic characteristics, such as the pitch, amplitude, frequency spectrum (amplitude), and the frequency spectrum envelope of the sound signal. Alternatively, the acoustic feature value sequence can be a time series of the spectrum envelope of the anharmonic component included in the sound signal.

In the present embodiment, two trained models M are stored in the memory unit 140. In the following, to distinguish between the two trained models M, one trained model M is referred to as trained model Ma and the other trained model M is referred to as trained model Mb. The acoustic feature value sequence generated by the trained model Ma is a pitch time series, and the control values input by the user are the variance and amplitude of the pitch. The acoustic feature value sequence generated by the trained model Mb is a time series of the frequency spectrum, and the control value input by the user is the amplitude.

The trained model M can generate an acoustic feature value sequence other than the pitch sequence or the frequency spectrum sequence (such as the slope, etc., of the frequency spectrum or the amplitude) and the control values input by the user can be acoustic feature values other than the amplitude or variance of the pitch.

The sound generation device 10 receives control values at each of a plurality of time points (time frames) on the time axis of the musical piece that is performed and also receives at a time point (desired time point), from among the plurality of time points, a mandatory instruction to make the acoustic feature value generated using the trained model M to follow the control value at that time point (specific time point) relatively strictly. If a mandatory instruction has not been received at that time point (specific time point), the sound generation device 10 updates the acoustic feature value sequence in temporary memory using the generated acoustic feature value. On the other hand, if a mandatory instruction has been received at that time point (specific time point), the sound generation device 10 generates one or more alternative acoustic feature values in accordance with the control value at that time point and updates the acoustic feature value sequence stored in the temporary memory using the generated alternative acoustic feature values.

Each piece of reference musical score data D2 represents a time series (musical score) which includes a plurality of musical notes arranged on a time axis and which constitute a musical piece. The musical score feature value sequence input to trained model M is a time series of feature values indicating the characteristics of a musical note at each time point on the time axis of the musical piece, generated from each piece of reference musical score data D2. Each piece of reference data D3 is a time series (that is, waveform data) of performance sound waveform samples obtained by playing the time series of the musical notes. The plurality of pieces of reference musical score data D2 and the plurality of pieces of reference data D3 correspond to each other. The reference musical score data D2 and corresponding reference data D3 are used by the training device 20 to construct the trained model M. Trained model M is constructed by the learning of the input/output relationship between a reference musical score feature value at each time point, a reference control value at that time point, as well as a reference acoustic feature value sequence immediately preceding that time point, and the reference acoustic feature value at that time point, via machine learning. Reference musical score data D2, reference data D3, and data derived therefrom (for example, volume or pitch variance) used in the training phase are called known data (data seen by the Model), as distinguished from unknown data (data unseen by the Model) not used in the training phase. Known control values, such as the reference volume or reference pitch variance, are derived data generated from reference data D3, and are used for training, whereas unknown control values refer to control values such as volume or pitch variance are not used for training.

Specifically, at each time point, from each piece of reference data D3, which are waveform data, the pitch sequence of the waveform is extracted as a reference pitch sequence, and the frequency spectrum of that waveform is extracted as a reference frequency spectrum sequence. The reference pitch sequence and the reference frequency spectrum sequence are examples of the reference acoustic feature value sequence. Further, at each time point, the pitch variance is extracted as the reference pitch variance from the reference pitch sequence, and the amplitude is extracted as a reference amplitude from the reference frequency spectrum sequence. The reference pitch variance and the reference amplitude are examples of reference control values.

The trained model Ma is constructed by the machine learning of the input/output relationship between the reference musical score feature value at each time point on the time axis, the reference pitch variance at that time point and the reference pitch immediately preceding that time point, and the reference pitch at that time point, via generative model m. The trained model Mb is constructed by the machine learning of the input/output relationship between the reference musical score feature value at each time point on the time axis, the reference amplitude at that time point and the reference frequency spectrum immediately preceding that time point, and the reference frequency spectrum at that time point.

Some or all of generative model m, trained model M, musical score data D1, reference musical score data D2, reference data D3, etc., can be stored on a computer-readable storage medium instead of the memory unit 140. Alternatively, in the case that the processing system 100 is connected to a network, some or all of generative model m, trained model M, musical score data D1, reference musical score data D2, reference data D3, etc., can be stored on a server on the network.

The operating unit (user operable input) 150 includes a keyboard or a pointing device such as a mouse and is operated by the user in order to indicate the control values or issue a mandatory instruction. The display unit (display) 160 includes a liquid-crystal display, for example, and displays a prescribed GUI (Graphical User Interface) for accepting the mandatory instruction or the indication of the control values from the user. The operating unit 150 and the display unit 160 can be configured as a touch panel display.

### (2) TRAINED MODEL

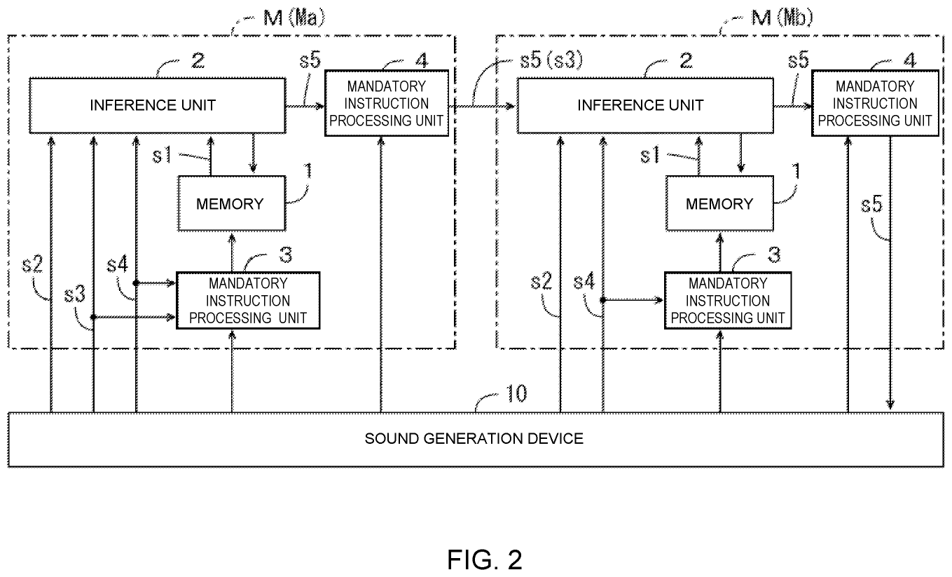

FIG. 2 is a block diagram of the configuration of trained model M serving as an acoustic feature value generator. As shown in FIG. 2, each of trained models Ma, Mb includes a temporary memory 1, an inference unit 2 that performs computations of the DNN, and mandatory instruction processing units 3, 4. The temporary memory 1 can be considered as part of the DNN algorithm. The generation unit 13 of the sound generation device 10, described further below, executes a generation process including the process of the trained model M. In the present embodiment, each of trained models Ma, Mb includes the mandatory instruction processing unit 4, but the mandatory instruction processing units 4 can be omitted. In that case, the acoustic feature value generated by the inference unit 2 at each time point on the time axis is output as the output data of trained model M.

Trained models Ma and Mb are two independent models, but have basically the same structure, so that similar elements have been given the same reference numerals for the sake of simplicity of explanation. The explanation of each element of trained model Mb basically follows the that of trained model Ma. The configuration of trained model Ma will be explained first. The temporary memory 1 operates, for example, as ring buffer memory and sequentially stores acoustic feature value sequences (pitch sequences) generated at a prescribed number of recent time points. Some of the prescribed number of acoustic feature values stored in the temporary memory 1 are replaced with corresponding alternative acoustic feature values, in accordance with mandatory instructions. Trained models Ma and Mb are independently provided with a first mandatory instruction related to pitch and a second mandatory instruction related to amplitude, respectively.

The inference unit 2 is provided with an acoustic feature value sequence s1 stored in the temporary memory 1. The inference unit 2 is also provided with a musical score feature value sequence s2, a control value sequence (pitch variance sequence and amplitude sequence) s3, and an amplitude sequence s4 as input data from the sound generation device 10. The inference unit 2 processes the input data (musical score feature value, pitch variance and amplitude as control values) for each time point on the time axis and the acoustic feature value sequence immediately preceding that time point, thereby generating the acoustic feature value (pitch) at that time point. As a result, a generated acoustic feature value sequence (pitch sequence) s5 is output from the inference unit 2.

The mandatory instruction processing unit 3 is provided with the first mandatory instruction from the sound generation device 10 at a certain time point (desired time point) from among the plurality of time points on the time axis. The mandatory instruction processing unit 3 is also provided with the pitch variance sequence s3 and the amplitude sequence s4 as control values from the sound generation device 10 at each of the plurality of time points on the time axis. If the first mandatory instruction is not provided at that time point, the mandatory instruction processing unit 3 uses the acoustic feature value (pitch) generated at that time point by the inference unit 2 to update the acoustic feature value sequence s1 stored in the temporary memory 1. Specifically, the acoustic feature value sequence s1 of the temporary memory 1 is shifted one place back, the oldest acoustic feature value is discarded, and the one most recent acoustic feature value is set as the generated acoustic feature value. That is, the acoustic feature value sequence of the temporary memory 1 is updated in FIFO (First In First Out) fashion. The one most recent acoustic feature value is synonymous with the acoustic feature value at that time point (current time point).

On the other hand, if the first mandatory instruction is provided at that time point, the mandatory instruction processing unit 3 generates alternative acoustic feature values (pitch) at one or more recent time points (1+α time points) in accordance with the control value (pitch variance) at that time point, and uses the generated alternative acoustic feature values to update the acoustic feature values of one or more recent time points from among the acoustic feature value sequence s1 stored in the temporary memory 1. Specifically, the acoustic feature value sequence s1 of the temporary memory 1 is shifted one place back, the oldest acoustic feature value is discarded, and the one or more recent acoustic feature value sequences are replaced with one or more generated alternative acoustic feature values. The tracking of the output data of the trained model Ma to the control values is improved if the alternative acoustic feature value that is generated is only one recent time point, but will be further improved if alternative acoustic feature values are generated and updated at 1+α recent time points. Alternative acoustic feature values of all of the time points in the temporary memory 1 can be generated. The updating of the acoustic feature value sequence of the temporary memory 1 using the alternative acoustic feature value of only one recent time point is the same operation as the updating by the above-described acoustic feature value sequence, and thus can be said to be FIFO-like. Updating using the alternative acoustic feature values of 1+α recent time points is almost the same operation as the updating by the above-described acoustic feature value sequence, except for the updates corresponding to the a portion, and is thus referred to as a quasi-FIFO-like update.

The mandatory instruction processing unit 4 is provided with the first mandatory instruction from the sound generation device 10 at a certain time point (desired time point) on the time axis. The mandatory instruction processing unit 4 is also provided with the acoustic feature value sequence s5 from the inference unit 2 at each time point on the time axis. If the first mandatory instruction is not provided at that time point, the mandatory instruction processing unit 4 outputs the acoustic feature value (pitch) generated by the inference unit 2 as the output data of the trained model Ma at that time point.

On the other hand, if the first mandatory instruction is provided at that time point, the mandatory instruction processing unit 4 generates one alternative acoustic feature value in accordance with the control value (pitch variance) at that time point and outputs the generated alternative acoustic feature value (pitch) as the output data of trained model Ma at that time point. The most recent of the one or more alternative acoustic feature values can be used as the one alternative acoustic feature value. That is, the mandatory instruction processing unit 4 need not generate an alternative feature value. In this manner, at a point in time at which the first mandatory instruction has not been issued, the acoustic feature value generated by the inference unit 2 is output from trained model Ma, and at a time point at which the first mandatory instruction has been issued, the alternative acoustic feature value is output from trained model Ma, and the acoustic feature value sequence (pitch sequence) s5 that has been output is provided to trained model Mb.

The trained model Mb will now be described, focusing on differences from trained model Ma. In trained model Mb, the temporary memory 1 sequentially stores the acoustic feature value sequences (frequency spectrum sequences) s1 of the prescribed number of immediately preceding time points. That is, the temporary memory 1 stores a prescribed number (several frames) of acoustic feature values.

The inference unit 2 is provided with the acoustic feature value sequence s1 stored in the temporary memory 1. Further, the inference unit 2 is provided with, as input data, the musical score feature value sequence s2 and the control value sequence (amplitude sequence) s4 from the sound generation device 10, and the pitch sequence s5 from the trained model Ma. The inference unit 2 processes the input data (musical score feature value, pitch, amplitude as a control value) of each time point on the time axis and the acoustic feature value immediately preceding that time point, to generate the acoustic feature value (frequency spectrum) at that time point. As a result, the generated acoustic feature value sequence (frequency spectrum sequence) s5 is output as the output data.

The mandatory instruction processing unit 3 is provided with the second mandatory instruction from the sound generation device 10 at a certain time point (desired time point) on the time axis. The mandatory instruction processing unit 3 is also provided with the control value sequence (amplitude sequence) s4 from the sound generation device 10 at each time point on the time axis. If the second mandatory instruction is not provided at that time point, the mandatory instruction processing unit 3 uses the acoustic feature value (frequency spectrum) generated at that time point by the inference unit 2 to update acoustic feature value sequence s1 stored in the temporary memory 1 in FIFO fashion. On the other hand, if the second mandatory instruction is provided at that time point, the mandatory instruction processing unit 3 generates one or more alternative acoustic feature values (frequency spectrum) in accordance with the control value (amplitude) at that time point and uses the generated alternative acoustic feature values to update one or more most recent acoustic feature values in the acoustic feature value sequence s1 stored in the temporary memory 1 in FIFO or quasi-FIFO fashion.

The mandatory instruction processing unit 4 is provided with the second mandatory instruction from the sound generation device 10 at a certain time point (desired time point) on the time axis. The mandatory instruction processing unit 4 is also provided with acoustic feature value sequence (frequency spectrum sequence) s5 from the inference unit 2 at each time point on the time axis. If the second mandatory instruction is not provided at that time point, the mandatory instruction processing unit 4 outputs the acoustic feature value (frequency spectrum) generated by the inference unit 2 as the output data of trained model Mb at that time point. On the other hand, if the second mandatory instruction is provided at that time point, the mandatory instruction processing unit 4 generates (or uses) the most recent alternative acoustic feature value in accordance with the control value (amplitude) at that time point, and outputs the alternative acoustic feature value (frequency spectrum) as the output data of trained model Mb at that time point. Acoustic feature value sequence (frequency spectrum sequence) s5 output from trained model Mb is provided to the sound generation device 10.

### (3) SOUND GENERATION DEVICE

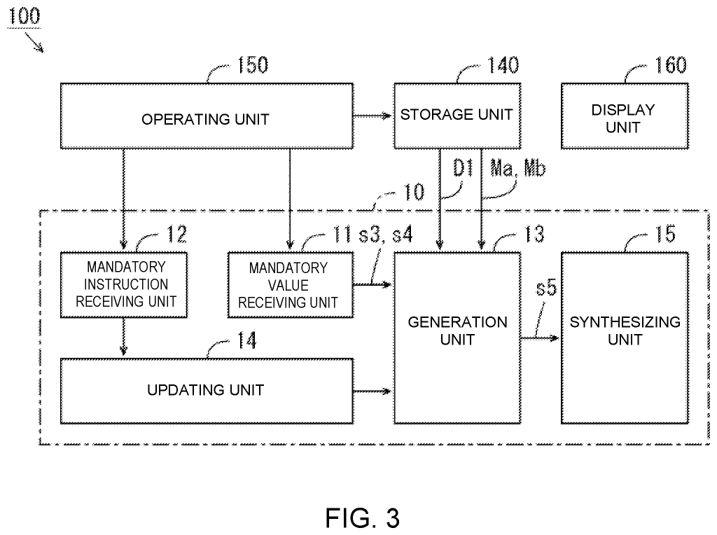

FIG. 3 is a block diagram showing the configuration of the sound generation device 10. As shown in FIG. 3, the sound generation device 10 includes a control value receiving unit 11, a mandatory instruction receiving unit 12, a generation unit 13, an updating unit 14, and a synthesizing unit 15 as functional units. The functional units of the sound generation device 10 are realized by the CPU 130 of FIG. 1 executing the sound generation program. At least some of the functional units of the sound generation device 10 can be realized in hardware, such as a dedicated electronic circuit.

The display unit 160 displays a GUI for accepting mandatory instructions or control value instructions. The user uses the operation unit 150 to operate the GUI, thereby issuing instructions pertaining to each of the pitch variance and the amplitude as control values at a plurality of time points on the time axis of a musical piece, and providing a mandatory instruction at a desired time point on the time axis. The control value receiving unit 11 receives the pitch variance and the amplitude as instructed by the GUI from the operation unit 150 at each time point on the time axis and provides the pitch variance sequence s3 and amplitude sequence s4 to the generation unit 13.

The mandatory instruction receiving unit 12 receives a mandatory instruction indicated by the GUI from the operation unit 150 at the desired time point on the time axis and provides the mandatory instruction that has been received to the generation unit 13. In lieu of provision from the operation unit 150, the mandatory instruction can be generated automatically. For example, in the case that musical score data D1 include mandatory instruction information indicating the time at which the mandatory instruction should be provided, the generation unit 13 can automatically generate a mandatory instruction at that time point on the time axis, and the mandatory instruction receiving unit 12 can receive the automatically generated mandatory instruction. Alternatively, the generation unit 13 can analyze the musical score data D1 that do not include the mandatory instruction information and detect an appropriate time point of the musical piece (such as a transition between piano and forte) to automatically generate a mandatory instruction at the detected time point.

The user operates the operating unit 150 to specify the musical score data D1 to be used for sound generation from among the plurality of musical score data D1 stored in memory unit 140 or the like. The generation unit 13 acquires trained models Ma, Mb stored in the memory unit 140 or the like, as well as musical score data D1 specified by the user. Further, the generation unit 13 generates a musical score feature value from the acquired musical score data D1 at each time point.

The generation unit 13 supplies the musical score feature value sequence s2, and the pitch variance sequence s3 and amplitude sequence s4 from the control value receiving unit 11 to the trained model Ma as input data. At each time point on the time axis, the generation unit 13 uses trained model Ma to process the input data at that time point (specific time point) (musical score feature value, pitch variance and amplitude as control values) and the pitch sequence generated immediately before the time point at which the data were stored in the temporary memory 1 of the trained model Ma, thereby generating and outputting the pitch at that time point.

The generation unit 13 also supplies the musical score feature value sequence s2, the pitch sequence output from trained model Ma, and amplitude sequence s4 from the control value receiving unit 11 to the trained model Mb as input data. At each time point on the time axis, the generation unit 13 uses trained model Mb to process the input data at that time point (specific time point) (musical score feature value, pitch, and amplitude as a control value) and the frequency spectrum sequence generated immediately before the time point at which the data were stored in the temporary memory 1 of trained model Mb, thereby generating and outputting the frequency spectrum at that time point.

If the mandatory instruction receiving unit 12 has not received a mandatory instruction at that time point (specific time point), the updating unit 14 uses the acoustic feature value generated by the inference unit 2 to update acoustic feature value sequence s1 stored in the temporary memory 1 in FIFO fashion via each of the mandatory instruction processing units 3 of trained models Ma, Mb. On the other hand, if a mandatory instruction has been received at that time point, the updating unit 14 generates one or more alternative acoustic feature values of one or more recent time points (one or more time points) in accordance with the control value at that time point via each of the mandatory instruction processing units 3 of trained models Ma, Mb and uses the generated alternative acoustic feature values to update acoustic feature value sequence s1 stored in the temporary memory 1 in FIFO or quasi-FIFO fashion.

Further, if the mandatory instruction receiving unit 12 has not received a mandatory instruction at that time point (specific time point), the updating unit 14 outputs the acoustic feature value generated by the inference unit 2 as the acoustic feature value of the acoustic feature value sequence s5 at that time point via each of the mandatory instruction processing units 4 of trained models Ma, Mb. On the other hand, if a mandatory instruction has been received at that time point, the updating unit 14 generates (or uses) the most recent alternative acoustic feature values in accordance with the control value at that time point via each of the mandatory instruction processing units 4 of trained models Ma, Mb to output the alternative acoustic feature values as the acoustic feature values of the acoustic feature value sequence s5 at the current time point.

The one or more alternative acoustic feature values at each time point are generated, for example, based on the control value at that time point and the acoustic feature value generated at that time point. In the present embodiment, the acoustic feature value at each time point is modified to fall within a permissible range in accordance with a target value and a control value at that time point, thereby generating an alternative acoustic feature value at that time point. A target value T is a typical value when the acoustic feature value follows the control value. The permissible range in accordance with the control value is defined by a Floor value and a Ceil value in the mandatory instruction. Specifically, the permissible range in accordance with the control value is defined by a lower limit value Tf (=T-Floor value) that is smaller than target value T of the control value by the Floor value, and an upper limit value Tc (=T+Ceil value) that is greater than target value T of the control value by the Ceil value.

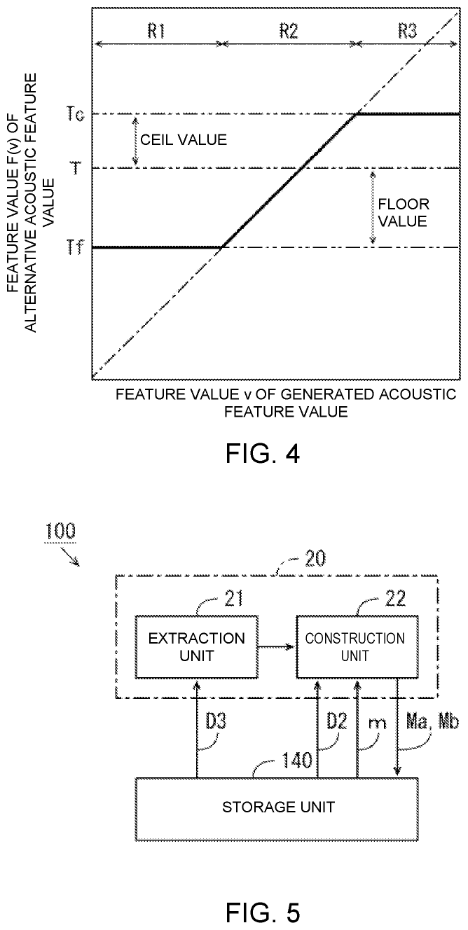

FIG. 4 is a diagram of the feature value modification characteristics between the original acoustic feature value and an alternative acoustic feature value generated from the original acoustic feature value. This feature value is of the same type as the control value. In FIG. 4, the horizontal axis indicates the feature value (volume, pitch variance, etc.) v of the acoustic feature value generated by the inference unit 2 of trained model M, and the vertical axis indicates the feature value F(v) of the modified acoustic feature value (alternative acoustic feature values).

As shown in range R1 of FIG. 4, when the feature value v of a given acoustic feature value is less than lower limit value Tf, the acoustic feature value is modified so that feature value F(v) is at lower limit value Tf, thereby generating the alternative acoustic feature value. As shown in range R2 of FIG. 4, when feature value v is greater than or equal to lower limit value Tf and less than or equal to upper limit value Tc, the unmodified acoustic feature value takes on the alternative acoustic feature value, so that feature value F(v) is the same as the feature value v. As shown in range R3 of FIG. 4, if the feature value v is greater than upper limit value Tc, the acoustic feature value is modified so that feature value F(v) takes on the upper limit value Tc, thereby generating the alternative acoustic feature value. For example, when the feature value v is pitch variance and is greater (or smaller) than upper limit value Tc, a coefficient (Tc/v) is used to scale the variance to be smaller (or larger) while maintaining the average of the generated pitches (acoustic feature values), thereby generating the alternative acoustic feature value. Further, when the feature value v is volume and is greater (or smaller) than upper limit value Tc, the entire frequency spectrum (acoustic feature value) is scaled using coefficient (Tc/v) so that the volume becomes smaller (or larger) to generate the alternative feature value.

In the case of generating alternative acoustic feature values of a plurality of time points, the same Floor value and Ceil value can be applied to each time point. Alternatively, the degree of modification of the feature value can be made smaller as the time point of the alternative acoustic feature value becomes less recent. Specifically, the Floor values and the Ceil values that precede the Floor value and the Ceil value of FIG. 4 as the current values can be set to larger values with increasing time. A greater number of points of substitution for alternative acoustic feature values would allow the generated acoustic feature values to follow the control values more quickly.

The synthesizing unit 15 functions as a vocoder, for example, to generate a sound signal, which is waveform processing in the time domain, from the acoustic feature value sequence (frequency spectrum sequence) s5 in the frequency domain generated by the mandatory instruction processing unit 4 of trained model Mb in the generation unit 13. The generated sound signal is supplied to a sound system that includes speakers, etc., connected to the synthesizing unit 15, thereby outputting sound that is based on the sound signal. In the present embodiment, the sound generation device 10 includes the synthesizing unit 15, but the embodiment is not limited in this way. The sound generation device 10 need not include the synthesizing unit 15.

### (4) TRAINING DEVICE

FIG. 5 shows a block diagram of the configuration of the training device 20. As shown in FIG. 5, the training device 20 includes an extraction unit 21 and a construction unit 22. The functional units of the training device 20 are realized by the CPU 130 of FIG. 1 executing the training program. At least part of the functional units of the training device 20 can be realized in hardware, such as dedicated electronic circuitry.

The extraction unit 21 analyzes each of the plurality of reference data D3 stored in the memory unit 140, etc., to extract a reference pitch sequence and a reference frequency spectrum sequence as reference acoustic feature value sequences. The extraction unit 21 also processes the extracted reference pitch sequence and the reference frequency spectrum sequence to respectively extract, as reference control value sequences, a reference pitch variance sequence, which is a time series of the variances of the reference pitch, and a reference amplitude sequence, which is a time series of the amplitudes of waveforms that correspond to the reference frequency spectrum.

The construction unit 22 acquires from the memory unit 140, etc., reference musical score data D2 and generative model m to be trained. Further, the construction unit 22 generates a reference musical score feature value sequence from reference musical score data D2, uses the reference musical score feature value sequence, reference pitch variance sequence, and reference amplitude sequence as input data, and the reference pitch sequence as the correct answer value of the output data, to train generative model m by machine learning. During training, the temporary memory 1 (FIG. 2) stores the reference pitch sequence immediately preceding each time point from the reference pitch sequences generated by generative model m.

The construction unit 22 uses generative model m to process the input data of each time point on the time axis (reference musical score feature value, reference pitch variance and reference volume as control values) and the reference pitch sequence immediately preceding that time point stored in the temporary memory 1, thereby generating the pitch at that time point. The construction unit 22 then adjusts the variables of generative model m such that the error between the generated pitch sequence and the reference pitch sequence (correct answer) becomes small. By repeating this training until the error becomes sufficiently small, a trained model Ma is constructed that has learned the input/output relationship between the output data (reference pitch) and the input data (reference musical score feature value, reference pitch variance, and reference amplitude) at each time point on the time axis.

Similarly, the construction unit 22 uses the reference musical score feature value sequence, reference pitch sequence, and reference amplitude sequence as input data, and the reference frequency spectrum sequence as the correct answer value of the output data to train generative model m by machine learning. During the training, from the reference frequency spectrum sequences generated by generative model m, the temporary memory 1 stores the reference frequency spectrum sequence immediately preceding each time point.

The construction unit 22 uses generative model m to process the input data of each time point on the time axis (reference musical score feature value, reference pitch, and reference amplitude as control value) and the reference frequency spectrum sequence immediately preceding each time point stored in the temporary memory 1, thereby generating the frequency spectrum at that time point. The construction unit 22 then adjusts the variables of generative model m so that the error between the generated frequency spectrum sequence and the reference frequency spectrum sequence (correct answer) becomes small. By repeating this training until the error becomes sufficiently small, a trained model Mb is constructed that has learned the input/output relationship between the output data (reference frequency spectrum sequence) and the input data (reference musical score feature value, reference pitch, and reference amplitude) at each time point on the time axis. The construction unit 22 stores the constructed trained models Ma, Mb in the memory unit 140 or the like.

### (5) SOUND GENERATION PROCESS

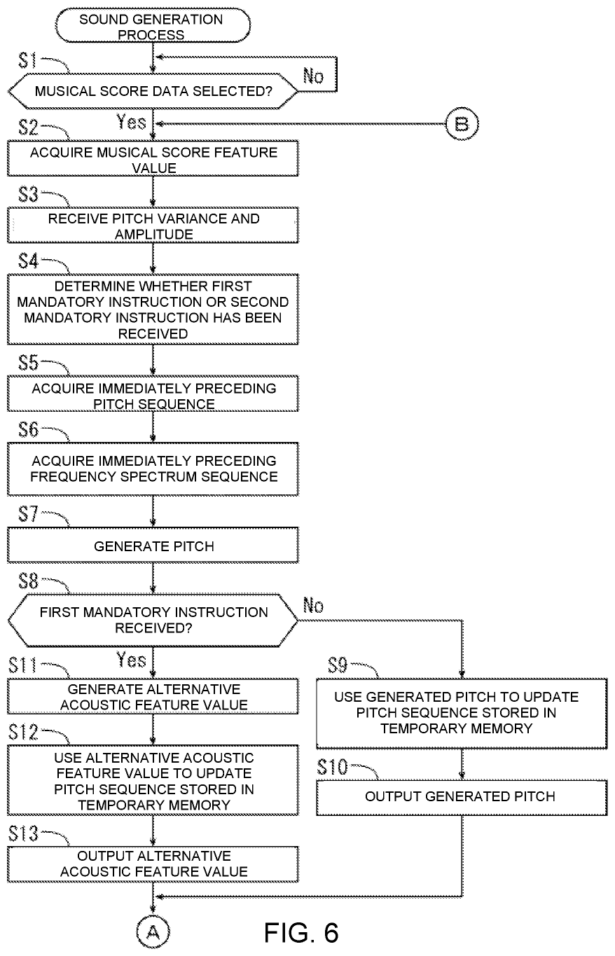

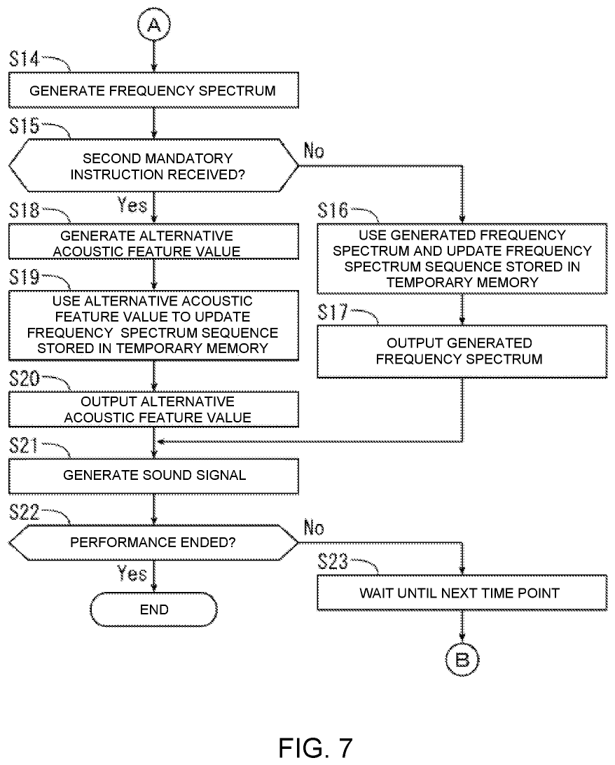

FIGS. 6 and 7 are flowcharts showing examples of sound generation processing performed by the sound generation device 10 of FIG. 3. The CPU 130 of FIG. 1 executes a sound generation program stored in the memory unit 140, etc., in order to perform the sound generation processes of FIGS. 6 and 7. The CPU 130 first determines whether the user has selected musical score data D1 of any musical piece (Step S1). If the musical score data D1 have not been selected, the CPU 130 waits until the musical score data D1 are selected.

If the musical score data D1 of a certain musical piece are selected, the CPU 130 sets the current time point t to the beginning of the musical score data (first time frame) and generates the musical score feature value of the current time point t from the musical score data D1 (Step S2). Further, the CPU 130 receives the pitch variance and amplitude input by the user at that time point as the control values of the current time point t (Step S3). Further, the CPU 130 determines if a first mandatory instruction or a second mandatory instruction has been received from the user at the current time point t (Step S4).

Further, the CPU 130 acquires the pitch sequences generated at a plurality of time points t immediately before the current time point t from the temporary memory 1 of the trained model Ma (Step S5). Further, the CPU 130 acquires the frequency spectrum sequence generated immediately before the current time point t from the temporary memory 1 of the trained model Mb (Step S6). Any of Steps S2-S6 can be executed first, or the steps can be executed simultaneously.

The CPU 130 then uses the inference unit 2 of the trained model Ma to process the input data (the musical score feature value generated in Step S1 and the pitch variance and amplitude received in Step S3), and the immediately preceding pitch acquired in Step S5, thereby generating the pitch of the current time point t (Step S7). The CPU 130 then determines whether a first mandatory instruction had been received in Step S4 (Step S8). If the first mandatory instruction has not been received, the CPU 130 uses the pitch generated in Step S7 to update the pitch sequence stored in the temporary memory 1 of the trained model Ma in FIFO fashion (Step S9). Further, the CPU 130 outputs the pitch as output data (Step S10) and proceeds to Step S14.

If the first mandatory instruction has been received, the CPU 130 generates one or more alternative acoustic feature values (alternative pitch) of one or more recent time points that follow the pitch variance based on the pitch variance received in Step S3 and the pitch generated in Step S7 (Step S11). The CPU 130 then uses the one or more generated alternative acoustic feature values of one or more time points to update the pitch stored in the temporary memory 1 of the trained model Ma in FIFO or quasi-FIFO fashion (Step S12). The CPU 130 then outputs the generated alternative acoustic feature value of the current time point as output data (Step S13) and proceeds to Step S14. Either Step S12 or S13 can be executed first, or the steps can be executed simultaneously.

In Step S14, the CPU 130 uses the trained model Mb to generate the frequency spectrum of the current time point t from the input data (the musical score feature value acquired in Step S1, the amplitude received in Step S3, and the pitch generated in Step S7) and the immediately preceding frequency spectrum acquired in Step S6 (Step S14). The CPU 130 then determines whether a second mandatory instruction had been received in Step S4 (Step S15). If the second mandatory instruction has not been received, The CPU 130 uses the frequency spectrum generated in Step S14 to update the frequency spectrum sequence stored in the temporary memory 1 of trained model Mb in FIFO fashion (Step S16). Further, the CPU 130 outputs the frequency spectrum as output data (Step S17) and proceeds to Step S21.

If the second mandatory instruction has been received, the CPU 130 generates alternative acoustic feature values (alternative frequency spectrum) of one or more recent time points that follow the amplitude, based on the amplitude received in Step S3 and the frequency spectrum generated in Step S14 (Step S18). The CPU 130 then uses the one or more generated alternative acoustic feature values of one or more time points to update the frequency spectrum sequence stored in the temporary memory 1 of the trained model Mb in FIFO or quasi-FIFO fashion (Step S19). Further, the CPU 130 outputs the generated alternative acoustic feature value of the current time point (Step S20) as output data and proceeds to Step S21. Either Step S19 or S20 can be executed first, or the steps can be executed simultaneously.

In Step S21, the CPU 130 uses any known vocoder technology to generate the sound signal of the current time point from the frequency spectrum output as the output data (Step S21). As a result, sound based on the sound signal of current time point (current time frame) is output from the sound system. The CPU 130 then determines whether the performance of the musical piece has ended, that is, if the current time point t of the performance of musical score data D1 has reached the end point of the musical piece (last time frame) (Step S22).

If the current time point t is not yet the performance end point, the CPU 130 waits until the next time point t (next time frame) (step S23) and returns to Step S2. The wait time until the next time point t is, for example, 5 milliseconds. The CPU 130 repeatedly executes Steps S2-S22 at each time point t (time frame) until the performance ends. Here, if the control values provided at each time point t need not be reflected in the sound signal in real time, the wait time in Step S23 can be omitted. For example, if the temporal changes of the control values are set in advance (the control values of each time point t are programmed in the musical score data D1), Step S23 can be omitted, and the process control can return to Step S2.

### (6) TRAINING PROCESS

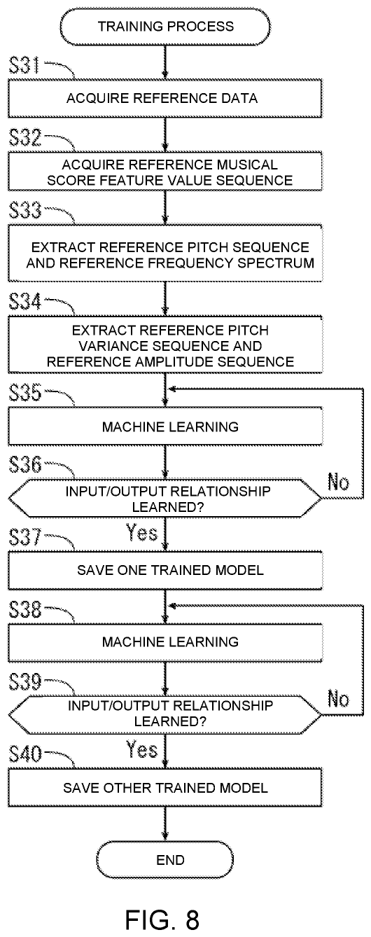

FIG. 8 shows a flowchart of an example of a training process conducted by the training device 20 of FIG. 5. The CPU 130 of FIG. 1 executes the training program stored in the memory unit 140, etc., to perform the training process of FIG. 8. First, the CPU 130 acquires the plurality of reference data D3 (waveform data of a plurality of musical pieces) used for training from the memory unit 140, etc., (Step S31). The CPU 130 then generates and obtains from reference musical score data D2 of the musical piece corresponding to each piece of the reference data D3 the reference musical score feature value sequence of the musical piece (Step S32).

The CPU 130 then extracts the reference pitch sequence and the reference frequency spectrum from each piece of reference data D3 (Step S33). The CPU 130 then processes the extracted reference pitch sequence and the reference frequency spectrum sequence to extract the reference pitch variance sequence and the reference amplitude sequence, respectively (Step S34).

The CPU 130 then acquires one generative model m to be trained and uses the input data (the reference musical score feature value sequence acquired in Step S32 and the reference amplitude sequence and the reference pitch variance sequence extracted in Step S34) and the output data of the correct answer (the reference pitch sequence extracted in Step S33) to train the generative model m. As described above, the variables of generative model m are adjusted such that the error between the pitch sequence generated by generative model m and the reference pitch sequence becomes small. The CPU 130 thereby causes generative model m to machine-learn the input/output relationship between the input data at each time point (reference musical score feature value, reference pitch variance, and reference amplitude) and the output data of the correct answer at that time point (reference pitch) (Step S35). During this training, in lieu of the pitches generated at a plurality of immediately preceding time points stored in the temporary memory 1, generative model m can process the pitches of a plurality of immediately preceding time points included in the reference pitch sequence with the inference unit 2 to generate the pitch at that time point.

The CPU 130 then determines whether the error has become sufficiently small, that is, whether generative model m has learned the input/output relationship (Step S36). If the error is still large and it is determined that machine learning is insufficient, the CPU 130 then returns to Step S35. Steps S35-S36 are repeated and the parameters are changed until generative model m learns the input/output relationship. The number of machine-learning iterations varies as a function of quality requirements (type of error calculated, threshold value used for determination, etc.) that must be met by one trained model Ma to be constructed.

Once it is determined that sufficient machine learning has been performed, the generative model m can be trained to learn the input-output relationship between the input data at a given time point (including the reference pitch variance and the reference amplitude) and the correct answer value (reference pitch) of the output data at that time point, and the CPU 130 stores the generative model m that has learned the input-output relationship as one of the trained models Ma (Step S37). In this manner, trained model Ma is trained to estimate the pitch at each time point based on an unknown pitch variance and the pitches at a plurality of immediately preceding time points. Here, an unknown pitch variance means a pitch variance not used in the training described above.

Further, the CPU 130 acquires one other generative model m to be trained and uses the input data (the reference musical score feature value sequence acquired in Step S32, the reference pitch sequence extracted in Step S33, and the reference amplitude sequence extracted in Step S34) and the output data of the correct answer (the reference frequency spectrum sequence) to train the generative model m. As described above, the variables of generative model m are adjusted such that the error between the frequency spectrum sequence generated by generative model m and the reference frequency spectrum sequence becomes small. The CPU 130 thereby causes generative model m to machine-learn the input/output relationship between the input data at each time point (reference musical score feature, reference pitch, and reference amplitude) and the output data of the correct answer at those time points (reference frequency spectrum) (Step S38). During this training, in lieu of the frequency spectrums generated at a plurality of immediately preceding time points stored in the temporary memory 1, generative model m can process the frequency spectra of a plurality of immediately preceding time points included in the reference frequency spectrum sequence using the inference unit 2 to generate the frequency spectrum at that time point.

TCPU 130 then determines whether the error has become sufficiently small, that is, whether the generative model m has learned the input/output relationship (Step S39). If the error is still large and it is determined that machine learning is insufficient, the CPU 130 returns to Step S38. Steps S38-S39 are repeated and the parameters changed until generative model m learns the input/output relationship. The number of machine-learning iterations varies as a function of quality requirements (type of error calculated, threshold value used for determination, etc.) that must be met by the other trained model Mb to be constructed.

Once it is determined that sufficient machine learning has been performed, the generative model m can be trained to learn the input-output relationship between the input data at a given time point (including the reference amplitude.) and the correct answer value (reference frequency spectrum) of the output data at that time point, the CPU 130 stores the generative model m that has learned the input-output relationship as the other trained model Mb (Step S40), and the training process is ended. In this manner, this trained model Mb is trained to estimate the frequency spectrum at each time point based on an unknown amplitude and the frequency spectra of a plurality of immediately preceding time points. Here, an unknown amplitude means an amplitude not used in the training. Any of Steps S35-S37 and Steps S38-S40 can be executed first, or the steps can be executed in parallel.

(7) Modified Examples

In the present embodiment, the CPU 130, as the updating unit 14, modifies the acoustic feature value at each time point to fall within a permissible range in accordance with a target value and a control value at that time point, thereby generating an alternative acoustic feature value at each time point, but the generation method is not limited in this way. For example, the CPU 130 can reflect the amount by which the feature value of the acoustic feature value at each time point exceeds a neutral range (instead of the permissible range) in accordance with the control value at that time point in the modification of the feature value at a prescribed rate to generate the alternative acoustic feature value at each time point. This rate is referred to as the Ratio value.

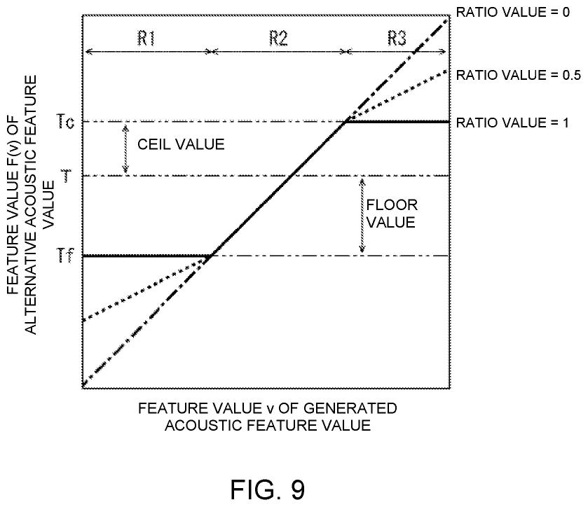

FIG. 9 is a diagram used to explain the generation of an alternative acoustic feature value in a first modified example. The upper limit value Tc of the neutral range is (T+Ceil value) and the lower limit value Tf is (T-Floor value). As shown in the range R1 of FIG. 9, in the first modified example, if the feature value v of a certain acoustic feature value is less than lower limit value Tf, the acoustic feature value is modified so that feature value v becomes feature value F(v)=v−)v−Tf)×Ratio value. As shown in range R2 of FIG. 9, if the feature value v is greater than or equal to the lower limit value Tf and less than or equal to the upper limit value Tc, the acoustic feature value is not modified, so that the feature value F(v) is the same as the feature value v. As shown in range R3 of FIG. 9, if the feature value v is greater than upper limit value Tc, the acoustic feature value is modified such that F(v)=v−(v−Tc)×Ratio value. In the case of generating alternative acoustic feature values of a plurality of time points, the Floor value and the Ceil value cannot be changed in accordance with the time point, and the Ratio value can be set to a smaller value as the time point becomes less recent.

In FIG. 9, the feature values F(v) of the acoustic feature value after modification when the Ratio value is 0, 0.5, and 1 are indicated by a thick dashed line, a thick dotted line, and a thick solid line, respectively. The feature value F(v) of the acoustic feature value after modification when the Ratio value is 0 is equal to the feature value v indicated by the thin dashed line of FIG. 4, and is not mandatory. The feature value F(v) of the acoustic feature value after modification when the Ratio value is 1 is equal to the feature value v of the acoustic feature value after modification indicated by the thick solid line of FIG. 4. By this configuration, if the acoustic feature value of the acoustic feature value sequence stored in the temporary memory 1 exceeds the neutral range, the excess amount can be reflected in the modification of the alternative acoustic feature value at a rate corresponding to the Ratio value.

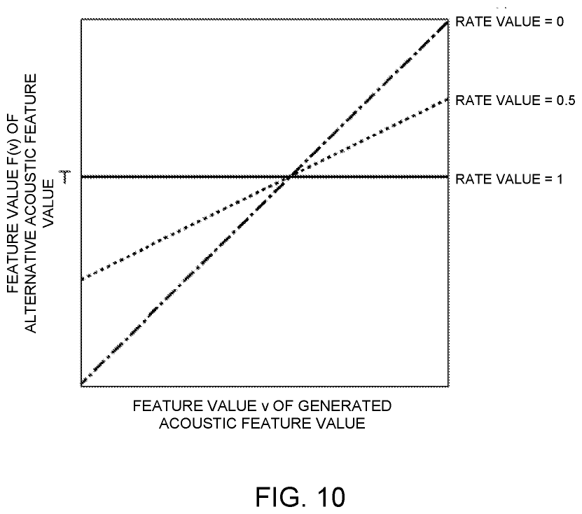

Alternatively, the CPU 130 can modify the acoustic feature value of each time point to approach the target value T in accordance with the control value at that time point at a rate corresponding to the Rate value to generate the alternative acoustic feature value of each time point. FIG. 10 is a diagram used to explain the generation of an alternative acoustic feature value in a second modified example. As shown in FIG. 10, in the second modified example, the acoustic feature value is modified such that feature value F(v)=v−(v−T)×Rate value over the entire range of feature value v. In the case of generating alternative acoustic feature values of a plurality of time points, the Rate value can be set to a smaller values as the time points becomes less recent.

In FIG. 10, feature values F(v) of the acoustic feature value after modification when the Rate value is 0, 0.5, and 1 are indicated by a thick dashed line, a thick dotted line, and a thick solid line, respectively. The feature value F(v) of the acoustic feature value after modification when the Rate value is 0 is equal to the feature value v indicated by the dashed line of FIG. 4 and is not mandatory. The feature value F(v) of the acoustic feature value after modification when the Rate value is 1 is equal to the target value T of the control value and is most strictly enforced.

### (8) EFFECTS OF THE EMBODIMENT

As described above, the sound generation method according to the present embodiment is realized by a computer and comprises receiving a control value indicating sound characteristics at each of a plurality of time points on a time axis; accepting a mandatory instruction at a desired time point on the time axis; using a trained model to process the control value at each time point and an acoustic feature value sequence stored in temporary memory, thereby generating an acoustic feature value at the time point; using the generated acoustic feature value to update the acoustic feature value sequence stored in the temporary memory if the mandatory instruction has not been received at that time point; and generating alternative acoustic feature values in accordance with the control value at that time point, and using the generated alternative acoustic feature values to update the acoustic feature value sequence stored in the temporary memory if the mandatory instruction has been received at that time point.

By the above-described method, even if at a given time point, the acoustic feature value generated using the trained model deviates from the value in accordance with the control value at that time point, an acoustic feature value that follows the control value relatively closely is generated without a significant delay from that time point by issuance of a mandatory instruction. It is thus possible to generate sound signals in accordance with the user's intentions.

By machine learning, the trained model can be trained to estimate the acoustic feature value at each time point based on the acoustic feature value of a plurality of immediately preceding time points.

The alternative acoustic feature value of each time point can be generated based on the control value at that time point and the acoustic feature value generated at that time point.

The acoustic feature value at each time point can be modified to fall within a permissible range corresponding to a control value at that time point, thereby generating an alternative acoustic feature value at each time point.

The permissible range in accordance with the control value can be defined by a mandatory instruction.

The amount by which the acoustic feature value at each time point exceeds a neutral range in accordance with the control value at that time point can be subtracted from the acoustic feature value at a prescribed rate to generate the alternative acoustic feature value at each time point.

The acoustic feature value at each time point can be modified so as to approach a target value in accordance with the control value at that time point, thereby generating an alternative acoustic feature value at each time point.

### (9) OTHER EMBODIMENTS

In the embodiment described above, both trained models Ma, Mb are used to generate the acoustic feature value of each time point, but the acoustic feature value of each time point can be generated using only one of trained models Ma, Mb. In this case, one of Steps S7 to S13 and the Steps S14 to S20 of the sound generation process is executed and the other is not executed.

In the former case, the pitch sequence generated in the executed Steps S7-S13 is supplied to the sound source, and the sound source generates a sound signal based on the pitch sequence. For example, the pitch sequence can be supplied to a phoneme connection type vocal synthesizer to generate vocals corresponding to the pitch sequence. Alternatively, the pitch sequence can be supplied to a waveform memory sound source, an FM sound source, or the like, to generate musical instrument sounds corresponding to the pitch sequence.

In the latter case, in Steps S14-S20, a pitch sequence generated by a known method other than use of the trained model Ma is received to generate a frequency spectrum sequence. For example, a pitch sequence handwritten by a user or a pitch sequence extracted from a musical instrument sound or the user's singing can be received, and a frequency spectrum sequence in accordance with the pitch sequence can be generated using the trained model Mb. In the former case, trained model Mb is not required, so that Steps S38-S40 of the training process need not be executed. Similarly, in the latter case, trained model Ma is not required, and Steps S35-S37 need not be executed.

Further, in the embodiment described above, supervised learning using reference data D2 is executed, but an encoder that generates a musical score feature value sequence from reference data D3 can be prepared, and unsupervised machine learning by reference data D3 can be executed without using reference musical score data D2. The encoder process is executed in Step S32 using reference data D3 as input in the training stage and is executed in Step S2 using a musical instrument sound or the user's singing as input in the usage phase.

Although the embodiment described above relates to a sound generation device that generates the sound signals of a musical instrument, the sound generation device can generate other types of sound signals. For example, the sound generation device can generate a speech sound signal from time-stamped text data. The trained model M in that case can be an AR type generative model that takes as input data a text feature value sequence generated from text data (instead of a musical score feature value) and a control value sequence indicating volume to generate a frequency spectrum feature value sequence.

In the embodiment described above, the user operates the operation unit 150 to input the control values in real time, but the user can program the time variation of the control values in advance and provide trained model M with control values that vary in accordance with the program to generate the acoustic feature value sequence at each time point.

### EFFECTS

By this disclosure, it is possible to use an AR generative model to generate sound signals in accordance with the intentions of the user.

What is claimed is:

1. A sound generation method realized by a computer, the sound generation method comprising:
receiving a control value indicating sound characteristics at each of a plurality of time points on a time axis;
accepting a mandatory instruction at a desired time point on the time axis;
generating an acoustic feature value of a specific time point, by using a trained model to process the control value at each of the plurality of time points and an acoustic feature value sequence stored in a temporary memory;
updating the acoustic feature value sequence stored in the temporary memory by using a generated acoustic feature value that has been generated, as the mandatory instruction has not been received for the specific time point; and
generating one or more alternative acoustic feature values of one or more time points, which includes at least the specific time point, in accordance with the control value for the specific time point, and updating the acoustic feature value sequence stored in the temporary memory by using the one or more alternative acoustic feature values, as the mandatory instruction has been received for the specific time point.

2. The sound generation method according to claim 1, wherein
the trained model is trained to estimate an acoustic feature value at each time point by machine learning, based on an unknown control value and based on acoustic feature values of a plurality of immediately preceding time points immediately prior to each time point.

3. The sound generation method according to claim 2, where
the acoustic feature value estimated by the trained model has a feature value in accordance with the unknown control value.

4. The sound generation method according to claim 1, wherein
the one or more alternative acoustic feature values are generated based on the control value for the specific time point and the acoustic feature value generated at the specific time point.

5. The sound generation method according to claim 3, wherein
the one or more alternative acoustic feature values are generated by modifying the acoustic feature value generated at the specific time point such that a feature value of the acoustic feature value generated at the specific time point, which is a same-type feature value as the control value, approaches the control value for the specific time point.

6. The sound generation method according to claim 3, wherein
the one or more alternative acoustic feature values are generated by modifying the acoustic feature value of the specific time point, such that a feature value of the acoustic feature value of the specific time point falls within a permissible range in accordance with the control value for the specific time point.

7. The sound generation method according to claim 6, wherein
the permissible range in accordance with the control value is defined by the mandatory instruction.

8. The sound generation method according to claim 3, wherein
the one or more alternative acoustic feature values are generated by modifying the acoustic feature value of the specific time point, such that a feature value of the acoustic feature value of the specific time point approaches a neutral range in accordance with the control value for the specific time point.

9. The sound generation method according to claim 3, wherein
the one or more alternative acoustic feature values are generated by modifying the acoustic feature value of the specific time point, such that a feature value of the acoustic feature value of the specific time point approaches a target value in accordance with the control value for the specific time point.

10. The sound generation method according to claim 1, wherein
the acoustic feature value sequence stored in the temporary memory is updated in FIFO fashion using the generated acoustic feature value.

11. The sound generation method according to claim 8, wherein
the acoustic feature value sequence stored in the temporary memory is updated in FIFO or quasi-FIFO fashion using the each of the one or more alternative acoustic feature values.

12. The sound generation method according to claim 1, wherein
the control value is pitch variance, and the acoustic feature value is pitch.

13. The sound generation method according to claim 1, wherein
the control value is amplitude, and the acoustic feature value is a frequency spectrum.

14. A sound generation device comprising:
at least one processor configured to execute
a control value receiving unit configured to receive a control value indicating sound characteristics at each of a plurality of time points on a time axis,
a mandatory instruction receiving unit configured to accept a mandatory instruction at a desired time point on the time axis,
a generation unit configured to generate an acoustic feature value of a specific time point by using a trained model to process the control value at each of the plurality of time points and an acoustic feature value sequence stored in a temporary memory, and
an updating unit configured to
update the acoustic feature value sequence stored in the temporary memory by using a generated acoustic feature value that has been generated, as the mandatory instruction has not been received for the specific time point, and
generate one or more alternative acoustic feature values of one or more time points, which includes at least the specific time point, in accordance with the control value for the specific time point, and update the acoustic feature value sequence stored in the temporary memory by using the one or more alternative acoustic feature values, as the mandatory instruction has been received for the specific time point.

15. The sound generation device according to claim 14, wherein
the updating unit is configured to generate the one or more alternative acoustic feature values based on the control value for the specific time point and the acoustic feature value generated at the specific time point.

16. The sound generation device according to claim 14, wherein
the updating unit is configured to generate the one or more alternative acoustic feature values by modifying the acoustic feature value generated at the specific time point such that a feature value of the acoustic feature value generated at the specific time point, which is a same-type feature value as the control value, approaches the control value for the specific time point.

17. The sound generation device according to claim 14, wherein
the updating unit is configured to generate the one or more alternative acoustic feature values by modifying the acoustic feature value of the specific time point, such that a feature value of the acoustic feature value of the specific time point falls within a permissible range in accordance with the control value for the specific time point.

18. The sound generation device according to claim 17, wherein
the permissible range in accordance with the control value is defined by the mandatory instruction.

19. The sound generation device according to claim 14, wherein
the updating unit is configured to generate the one or more alternative acoustic feature values by modifying the acoustic feature value of the specific time point, such that a feature value of the acoustic feature value of the specific time point approaches a neutral range in accordance with the control value for the specific time point.

20. The sound generation device according to claim 14, wherein
the updating unit is configured to generate the one or more alternative acoustic feature values by modifying the acoustic feature value of the specific time point, such that a feature value of the acoustic feature value of the specific time point approaches a target value in accordance with the control value for the specific time point.
